(19) United States
(12) Patent Application Publication
(10) Pub. No.: US 2017/0051127 A1
(43) Pub. Date: Feb. 23, 2017

(54) POLYAMIDE COMPOSITIONS

(71) Applicant: LANXESS Deutschland GmbH, Cologne (DE)

(72) Inventors: Joachim MORICK, Leverkusen (DE); Matthias BIENMUELLER, Krefeld (DE); Jochen ENDTNER, Cologne (DE)

(21) Appl. No.: 15/238,997

(22) Filed: Aug. 17, 2016

(30) Foreign Application Priority Data
Aug. 21, 2015 (EP) 15181927.3

(51) Int. Cl. C08K 3/38; C08K 5/20; C08K 3/34; B29C 49/00; B29B 13/04; B29B 9/06; B29C 45/00; B29C 47/00; C08K 3/22; B29B 7/48

(52) U.S. Cl. CPC C08K 3/38; C08K 3/22; C08K 5/20; C08K 3/34; B29B 7/48; B29B 13/04; B29B 9/06; B29C 45/0001; B29C 47/0004; B29C 49/0005; C08K 2003/385; C08K 2003/2224; C08K 2003/2241; B29K 2077/00

(57) ABSTRACT

Polyamide-based compositions may include boron nitride and magnesium hydroxide for enhanced flame retardancy requirements, enhanced heat conductivity and isotropic shrinkage while providing adequate mechanical properties, for articles of manufacture produced therefrom.

The present invention relates to polyamide-based compositions comprising boron nitride and magnesium hydroxide and to the use of these compositions for producing articles of manufacture having enhanced flame retardancy requirements, enhanced heat conductivity and isotropic shrinkage coupled with adequate mechanical properties.

### BACKGROUND INFORMATION

In the process of injection moulding glass fibre reinforced thermoplastic moulding materials, various coupled and simultaneous flow forms occur depending on the component part. While, for example, extensional flows tend to orient the short glass fibres radially around the injection point, the shear flows occurring over the flow cross section bring about rotation of the fibres. Depending on the plastic employed, on the geometry of the component part and on the process conditions, a three-layer distribution of the short glass fibres employed as filler is obtained. At the edge of the component part, said fibres tend to be oriented in the direction of moulding, while in the middle a transverse orientation tends to prevail.

The resulting layer thicknesses depend very strongly on the rheological properties of the melt. Depending on the flow geometry and the degree of structural viscosity different layer thickness distributions are established for the component part. The property of fillers such as glass fibres to exhibit different physical properties in different directions is described as anisotropy.

The mechanical properties in particular are affected to a significant extent by the anisotropic fibre distribution. Depending on the fibre content both stiffness and also tolerable stress may differ by up to a factor of 2 as a function of direction, see: http://www.plasticsportal.net/wa/plasticsEU˜de_DE/portal/show/content/technical_resources/ultrasim/ultrasim_work_areas_anisotropie

Thus, in glass fibre reinforced plastics in particular, anisotropy should be taken into account. Reinforcements in the form of microfibres and microbodies made of glass, carbon etc. embedded in the plastic imbue the mechanically loaded component part with improved stiffness, enhanced mechanical strength and heat resistance. The plastic matrix distributes the load acting on the component part over the reinforcers and brings together the individual components of the material to afford a complementary material system.

EP 0 605 861 A2 discloses halogen-free, flame resistant, glass fibre reinforced polyamide moulding materials which comprise, inter alia, magnesium hydroxide as a flame-resistance-imparting component. The disadvantage of the compositions in EP 0 605 861 A2 is the fact that while a V0 flame resistance classification rating is possible, isotropic shrinkage cannot be achieved on account of the use of the glass fibres and additionally only an inadequate heat conductivity of less than 1 W/(m·K) is possible.

WO 2014/202649 A1 describes polyamide 6 or polyamide 66 moulding materials which comprise boron nitride as a conductivity filler and at least one reinforcing filler and have a high thermal conductivity and high mechanical characteristics.

Proceeding from this prior art the problem addressed by the present invention was that of providing halogen-free, flame retardant, polyamide-based moulding materials and articles of manufacture producible therefrom having a heat conductivity greater than 1.0 W/(m·k) (measured perpendicular to the flow direction, through-plane) and a very largely isotropic shrinkage which at least achieve a V0 rating, exhibit a GWFI of at least 850° C. even at a wail thickness of 0.75 mm and retain the mechanical properties in terms of flexural strength and especially edge fibre elongation required for applications in articles of manufacture and components for current and voltage conducting component parts, wherein very largely isotropic shrinkage or low-warpage shrinkage is to be understood in accordance with the invention as meaning shrinkage where the quotient of processing shrinkage parallel to the direction of moulding and processing shrinkage perpendicular to the direction of moulding is greater than 0.8, preferably greater than 0.9.

Due to the use in voltage-conducting parts the enhanced heat conductivity must not be accompanied by enhanced electrical conductivity and the specific surface resistance must, as far as possible, not fall below 1E11 ohms measured as per IEC60093.

Due to the potential opportunities for use in LED applications a reflection of at least 80% is moreover deemed advantageous and is sought. To provide a value for reflection, gloss at 500 nm as per DIN 5033-4 is measured. In the context of the present invention said gloss was determined on a Minolta (CM2600D) spectrophotometer using D65 light.

### SUMMARY

The solution to the problem and the subject-matter of the present invention are compositions comprising
a) polyamide 6 or polyamide 66,
b) magnesium hydroxide having an Si content of <15 000 ppm and
c) boron nitride.

It is noted for the avoidance of doubt that the scope of the invention encompasses all hereinbelow-listed definitions and parameters referred to in general terms or within preferred ranges in any desired combinations.

### EMBODIMENTS

The present invention preferably relates to compositions which, additionally, comprise component b) in a purity of at least 96 wt %

The present invention particularly preferably relates to compositions in which component b) additionally has an Fe content of <1500 ppm.

The present invention preferably relates to compositions further comprising, in addition to a), b) and c), d) titanium dioxide.

The present invention preferably relates to compositions further comprising, in addition to components a), b), c) and d),
e) at least one heat stabilizer from the group of sterically hindered phenols comprising at least one structure of formula (I),

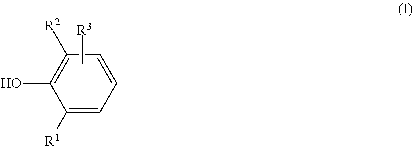

where R¹ and R² represent an alkyl group, a substituted alkyl group or a substituted triazole group, wherein radicals R¹ and R² may be identical or different and R³ represents an alkyl group, a substituted alkyl group, an alkoxy group or a substituted amino group.

In an alternative embodiment the present invention relates to compositions comprising, in addition to components a), b) and c), i.e. without d),
e) at least one heat stabilizer from the group of sterically hindered phenols comprising at least one structure of formula (I),

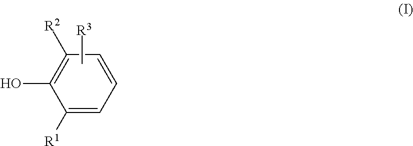

where R¹ and R² represent an alkyl group, a substituted alkyl group or a substituted triazole group, wherein radicals R¹ and R² may be identical or different and R³ represents an alkyl group, a substituted alkyl group, an alkoxy group or a substituted amino group.

It is preferable when per 100 parts by weight of component a) 100 to 280 parts by weight of component b) and 10 to 150 parts by weight of component c) are employed. It is particularly preferable when per 100 parts by weight of component a) 120 to 250 parts by weight of component b) and 15 to 60 parts by weight of component c) are employed. It is very particularly preferable when per 100 parts by weight of component a) 150 to 210 parts by weight of component b) and 20 to 45 parts by weight of component c) are employed.

In the case of additional use of component d), 1 to 150 parts by weight, preferably 10 to 100 parts by weight and particularly preferably 30 to 70 parts by weight of titanium dioxide are employed per 100 parts by weight of component a).

In the case of additional use of component e), 0.01 to 3 parts by weight, preferably 0.05 to 1 parts by weight and particularly preferably 0.1 to 0.5 parts by weight of heat stabilizer are employed per 100 pads by weight of component a).

The compositions according to the invention, also generally referred to in the plastics industry as moulding materials, are obtained upon processing components a) to c) and optionally d) and e), preferably as pelletized material, in the form of extrudates or as powder. Preparation is effected by mixing the inventive compositions in at least one mixing apparatus, preferably a compounder, particularly preferably a corotating twin-screw extruder. The procedure of mixing of components a) to c) and optionally at least one further component d) and/or e) to produce compositions according to the invention in the form of powders, pelletized materials or extrudates is often also referred to in the plastics industry as compounding. This affords as intermediates moulding materials based on the compositions according to the invention. These moulding materials—also known as thermoplastic moulding materials—may either be composed exclusively of components a), b) and c) or else may comprise, in addition to components a), b) and c), further components, preferably at least one of components d) and/or e) and/or hereinbelow-defined components f) to h). In the case of the moulding materials and articles of manufacture producible therefrom, the proportion of the compositions according to the invention present therein is preferably in the range from 40 to 100 wt %, the remaining constituents being added substances selected by those skilled in the art according to the subsequent use of the articles of manufacture, preferably from at least one of components d) to h). When the moulding materials comprise, in addition to components a), b) and c), further components, in particular at least one of the hereinbelow-listed components d) and/or e) and/or f) and/or g) and/or h), the proportion of at least one of components a), b), c) is reduced by an extent such that the sum of all weight percentages in the moulding material is 100.

In a preferred embodiment the compositions and the moulding materials and articles of manufacture producible therefrom further comprise, in addition to components a) to e) or instead of components d) and/or a), f) at least one filler from the group of glass beads, ground glass, amorphous silica, calcium silicate, calcium metasilicate, magnesium carbonate, kaolin, calcined kaolin, chalk, mica, phlogopite, barium sulphate, feldspar and montmorillonite. It is preferable when per 100 parts by weight of component a) 5 to 100 parts by weight, particularly preferably 10 to 60 parts by weight, very particularly preferably 20 to 40 parts by weight, of component f) are employed.

In a preferred embodiment the compositions and the moulding materials and articles of manufacture producible therefrom further comprise, in addition to components a) to f) or instead of components d) and/or e) and/or f), g), at least one demoulding agent. It is preferable when per 100 parts by weight of component a) 0.05 to 5 parts by weight, particularly preferably 0.2 to 2 parts by weight, very particularly preferably 0.5 to 1.6 parts by weight, of component g) are employed.

In a preferred embodiment the compositions and the moulding materials and articles of manufacture producible therefrom further comprise, in addition to components a) to g) or instead of components d) and/or e) and/or f) and/or g), h) at least one additive. It is preferable when per 100 parts by weight of component a) 0.01 to 10 parts by weight, particularly preferably 0.05 to 5 parts by weight, very particularly preferably 0.1 to 2 parts by weight, of component h) are employed.

Component a)

As component a), the compositions comprise PA 6 [CAS No. 25038-54-4] or PA 66 [CAS No. 32131-17-2]. Copolyamides based on PA 6 and/or PA 66 are encompassed by the subject-matter of the present invention.

The nomenclature of the polyamides used in the context of the present application corresponds to the international standard, the first number(s) denoting the number of carbon atoms in the starting diamine and the last number(s) denoting the number of carbon atoms in the dicarboxylic acid. If only one number is stated, as in the case of PA6, this means that the starting material was an α,ω-aminocarboxylic acid or the lactam derived therefrom, i.e. ε-caprolactam in the case of PA 6; for further information, reference is made to H. Domininghaus, Die Kunststoffe und ihre Eigenschaften, pages 272 ff., VDI-Verlag, 1976. Preferably employed as component a) is polyamide 6 or polyamide 66 having a viscosity number in the range from 80 to 180 ml/g determined in a 0.6 wt % solution in 96 wt % sulphuric acid at 25° C. as per ISO 307.

Particularly preferably employed as component a) is polyamide 6 having a viscosity number in the range from 85 to 160 ml/g, very particularly preferably having a viscosity number in the range from 90 to 140 ml/g.

Particularly preferably employed as component a) is polyamide 66 having a viscosity number in the range from 100 to 170 ml/g, very particularly preferably having a viscosity number in the range from 110 to 160 ml/g.

Viscosity measurements in solution are used to determine the K value, a molecular parameter by which the flow properties of plastics can be characterized, in simplified form: [η]=2.303×(75 k²+k) where K value=1000 k and [η]=Staudinger viscosity. The viscosity number J in cm³/g can be determined therefrom according to DIN 53726 without any complicated conversion.

$$J = ( \frac{η}{{η}_{0}} - 1 ) \cdot \frac{1}{c}$$

See http://www.mhaeberl.de/KUT/3Kunststoffschmelze.htm. In practice, tables for converting the K value into viscosity number J exist.

In accordance with Hans Domininghaus' “Die Kunststoffe und ihre Eigenschaften”, 5th edition (1998), p. 14, the term thermoplastic polyamides is to be understood as meaning polyamides whose molecular chains have no side branches or else have side branches which are of greater or lesser length and differ in number, which soften when heated and which are virtually infinitely mouldable.

The PA6 and PA66 to be employed as component a) according to the invention may be produced by various methods and in one embodiment may be combined with processing aids, stabilizers or else polymeric alloy partners, preferably elastomers, to afford materials having specific combinations of properties. Also suitable are blends comprising proportions of other polymers, preferably of polyethylene, polypropylene, acrylonitrile-butadiene-styrene copolymer (ABS), one or more compatibilizers being optionally employable. The properties of the PA6 and PA66 to be employed as component a) can be improved by addition of elastomers, for example in terms of impact resistance. The multitude of possible combinations permits a very large number of products having a very wide variety of different properties.

A multitude of procedures for preparing polyamides has become known, with use, depending on the desired end product, of different monomer units and various chain transfer agents to establish a desired molecular weight or else monomers with reactive groups for aftertreatments intended at a later stage.

The methods of industrial relevance for preparing polyamides usually proceed via polycondensation in the melt. In the context of the present invention the hydrolytic polymerization of lecterns is also considered to be polycondensation.

The polyamides PA 6 and PA 66 to be employed as component a) are semicrystalline polyamides. According to DE 10 2011 084 519 A1 semicrystalline polyamides have an enthalpy of fusion in the range from 4 to 25 J/g measured by the DSC method according to ISO 11357 upon 2nd heating and integration of the melt peak. By contrast, amorphous polyamides have an enthalpy of fusion of less than 4 J/g measured by the DSC method according to ISO 11357 upon 2nd heating and integration of the melt peak.

The polyamide 6 to be employed as component a) is obtainable from ε-caprolactam. The polyamide 66 to be employed as component a) is obtainable from hexamethylenediamine and adipic acid.

Preference is further given to most compounds based on PA 6, PA 66 or copolyamides thereof where there are 3 to 11 methylene groups, especially very particularly preferably 4 to 6 methylene groups, for each polyamide group in the polymer chain.

PA6 is very particularly preferred compared to PA66 according to the invention.

Polyamide 6 is obtainable for example under the name Durethan® B26 from Lanxess Deutschland GmbH, Cologne, and polyamide 66 under the name Ultramid® A27E from BASF SE, Ludwigshafen.

Component b)

Magnesium hydroxide [CAS Nr. 130942-8] may be impurified as a result of its origin and mode of production. Typical impurities include for example silicon-, iron-, calcium- and/or aluminium-containing species which may for example be present in the form of oxides as guest species in the magnesium hydroxide crystals. The purity of the magnesium hydroxide results from a proportion of species other than magnesium hydroxide that is as small as possible. The magnesium hydroxide to be employed as component b) has a silicon proportion determinable by X-ray fluorescence (XRF) on calcined substance as per ISO 12677 of <15 000 ppm, preferably <5000 ppm and particularly preferably <500 ppm.

The magnesium hydroxide to be employed in accordance with the invention preferably has a purity, i.e. an Mg(OH)₂ proportion, of at least 96 wt %, preferably at least 98 wt %.

Finally, in a preferred embodiment the magnesium hydroxide to be employed in accordance with the invention, in addition to the silicon content and/or in addition to the purity, has an iron content (Fe) determinable by X-ray fluorescence (XRF) on calcined substance as per ISO 12677 of <1500 ppm, preferably <1000 ppm, particularly preferably <300 ppm.

In particular, the magnesium hydroxide is of non-mineral, i.e. synthetic, origin. Preferably contemplated methods of producing component b) of synthetic origin are pyrohydrolysis of aqueous magnesium chloride solutions or precipitation of magnesium salt solutions with calcined slaked dolomite or milk of lime.

Magnesium hydroxide to be employed as component b) may be unsized or else sized. A size is an impregnation liquid applied by spraying or immersion before further processing of a component, in this case the magnesium hydroxide, to improve the profile of properties or processing of a component. Component b) is preferably provided with sizes based on stearates or aminosiloxanes, particularly preferably with aminosiloxanes.

Magnesium hydroxide preferably employed as component b) has an average particle size d50 in the range from 0.5 μm to 6 μm, preference being given to a d50 in the range from 0.7 μm to 3.8 μm and particular preference being given to a d50 in the range from 1.0 μm to 2.6 μm. A suitable measuring method for determining the d50 is for example laser diffraction, measured with a Malvern Mastersizer 2000 for example. The desired particle sizes may for example be achieved by grinding magnesium hydroxide. In connection with the average particle sizes in this application, their determination and their significance, reference is made to Chemie Ingenieur Technik (72) pp. 273-276, 3/2000, Wiley-VCH Verlags GmbH, Weinheim, 2000, according to which the d50 value is that particle size below which 50% of the amount of particles lie (median value). The d50 value of component b) is determined in accordance with the invention by laser diffraction (light scattering) as per ISO 13320 after dispersion in water as per ISO 14887. Alternative dispersants are described in table 2 of the white paper “Dispersing Powders in Liquid for Particle Size Analysis” from Horiba Instruments Inc, Albany, N.Y., 2013.

Magnesium hydroxide types suitable in accordance with the invention include for example Magnifin® H5IV from Martinswerk GmbH, Bergheim, Germany or Hidromag® Q2015 TC from Penoles, Mexico City, Mexico.

Component c)

The boron nitrides to be employed as component c) [CAS No. 10043-11-5] preferably have an average particle size (d50) based on the primary particles in the range from 0.5 μm to 100 μm, an average particle size in the range from 2 μm to 50 μm being preferred and an average particle size in the range from 5 μm to 20 μm being particularly preferred. In the context of the present invention the average particle sizes of component c) are determined by means of laser diffraction in a dispersion as per ISO 13320.

The boron nitride is preferably employed directly in the form of platelets or in the form of agglomerates, the use of platelets being particularly preferred.

Similarly to component b), component c) may likewise be employed in unsized form or else in surface-modified form. Suitable boron nitride qualities include for example BT BN006-HM and/or BT BN012-TCP boron nitride from RD Consulting, Oberscheinfeld, Germany.

Component d)

The titanium dioxide to be employed as component d) [CAS No. 13463-67-7] preferably has an average particle size in the range from 90 nm to 2000 nm, particularly preferably in the range from 200 nm to 800 nm, to be determined by means of laser diffraction in a dispersion as per ISO 13320.

Titanium dioxide pigments contemplated as the titanium dioxide to be employed as component d) in accordance with the invention are those whose basic structures may be produced by the sulphate (SP) or chloride (CP) method and which have an anatase and/or ruble structure, preferably a rutile structure. The basic structure need not be stabilized, but a specific stabilization is preferred: in the case of the CP basic structure via Al doping of 0.3-3.0 wt % (calculated as Al₂O₃) and an oxygen excess in the gas phase during the oxidation of the titanium tetrachloride to titanium dioxide of at least 2%; in the case of the SP basic structure via doping preferably with Al, Sb, Nb or Zn. Particular preference is given to “light” stabilization with Al, or in the case of higher amounts of Al doping to compensation with antimony. When titanium dioxide is used as white pigment in paints and coatings, plastics etc., it is known that unwanted photocatalytic reactions caused by UV absorption lead to breakdown of the pigmented material. This involves absorption of light in the near ultraviolet range by titanium dioxide pigments, thus forming electron-hole pairs which produce highly reactive free radicals on the titanium dioxide surface. The free radicals formed result in binder decomposition in organic media. Preference is given in accordance with the invention to lowering the photoactivity of the titanium dioxide by inorganic aftertreatment thereof, particularly preferably with oxides of Si and/or Al and/or Zr and/or through the use of Sn chemistries.

Preferably, the surface of pigmentary titanium dioxide is covered with amorphous precipitated oxide hydrates of the chemistries SiO₂ and/or Al₂O₃ and/or zirconium oxide. The Al₂O₃ shell facilitates pigment dispersion in the polymer matrix and the SiO₂ shell impedes charge exchange at the pigment surface and hence prevents polymer degradation.

In accordance with the invention the titanium dioxide is preferably provided with hydrophilic and/or hydrophobic organic sizes, in particular with siloxanes or polyalcohols.

Commercially available products are, for example, Kronos® 2230, Kronos® 2233 and Kronos® 2225 from Kronos, Dallas, USA. The titanium dioxide can be used directly as a powder or in the form of masterbatches, in which case the masterbatches are preferably based on polyamide. Alternatively, it is also possible to use titanium dioxide masterbatches based on polycarbonate, polybutylene terephthalate, polyethylene, maleic anhydride-grafted polyethylene and/or maleic anhydride-grafted polypropylene, and it is also possible to use a mixture of said polymers for the masterbatch.

Component e)

In one embodiment the compositions according to the invention comprise at least one heat stabilizer from the group of sterically hindered phenols comprising at least one structure of formula (I)

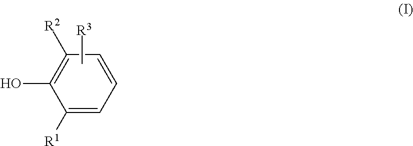

where R¹ and R² represent an alkyl group, a substituted alkyl group or a substituted triazole group, wherein radicals R¹ and R² may be identical or different and R³ represents an alkyl group, a substituted alkyl group, an alkoxy group or a substituted amino group.

Sterically hindered and thus demanding groups in the context of the present invention are preferably tert-butyl groups, isopropyl groups, and aryl groups substituted with sterically demanding groups. Sterically demanding groups in the context of the present invention are in particular tert-butyl groups.

Very particularly preferred heat stabilizers of formula (I) are described as antioxidants for example in DE-A 27 02 661 (U.S. Pat. No. 4,360,617), the content of which is fully encompassed by the present application. A further group of preferred sterically hindered phenols is derived from substituted benzenecarboxylic acids, in particular from substituted benzenepropionic acids. Particularly preferred chemistries from this class are chemistries of formula (II)

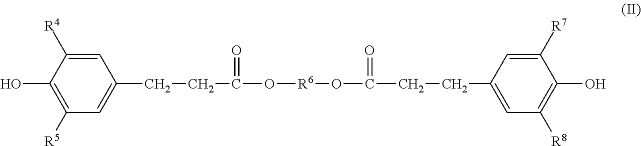

wherein R⁴, R⁵, R⁷ and R⁸ independently of one another represent C₁-C₈-alkyl groups, which may themselves be substituted and of which at least one is a sterically demanding group, and represents a divalent aliphatic radical having 1 to 10 carbon atoms, which may also have C—O bonds in the main chain. Examples of chemistries of formula (II) include chemistries of formulae (III), (IV) and (V).

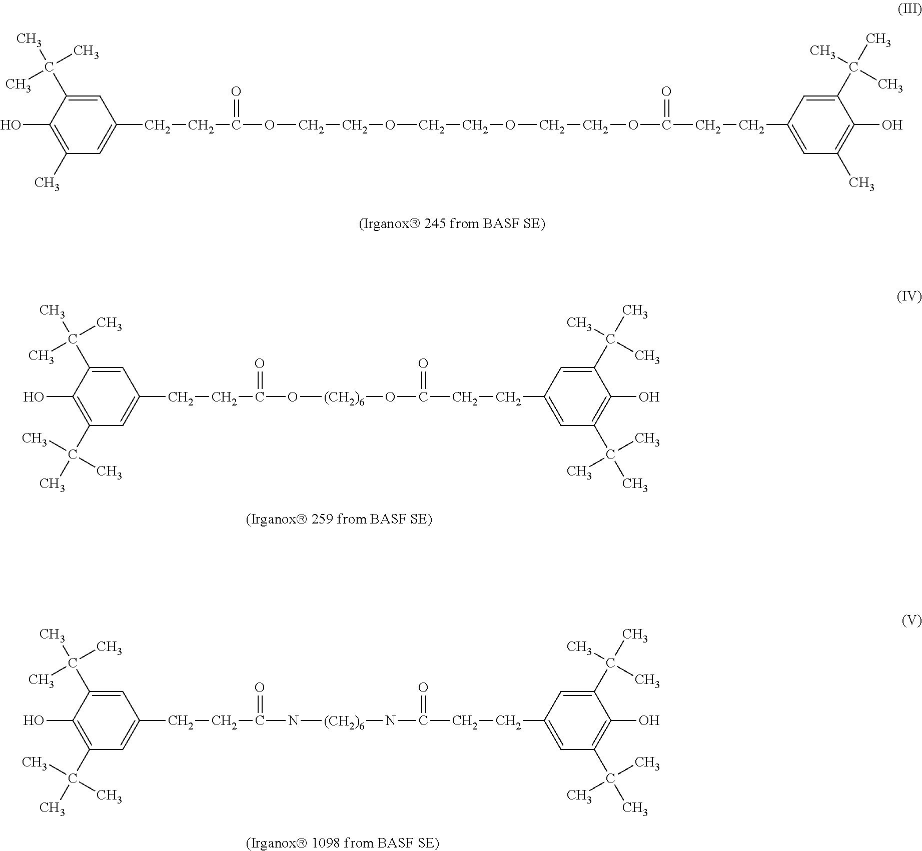

Very particularly preferred heat stabilizers are selected from the group of 2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Especially preferred heat stabilizers are selected from the group consisting of 2,2′-methylenebis(4-methyl-6-tert-butylphenol), 1,6-hexanediol bis[3-(3,5-di-tert-butyl-4-hydroxyphenyl)propionate] (Irganox® 259), pentaerythrityl tetrakis[3,5-di-tert-butyl-4-hydroxyphenyl)propionate] and N,N′-hexamethylenebis-3,5-di-tert-butyl-4-hydroxyhydrocinnamide (Irganox® 1098) and the hereinabove-described Irganox® 245 from BASF SE, Ludwigshafen, Germany.

The use of N,N′-hexamethylenebis-3,5-di-tert-butyl-4-hydroxyhydrocinnamide [CAS No. 23128-74-7] as heat stabilizer, available under the name Irganox® 1098 from BASF SE, Ludwigshafen, Germany, is especially very particularly preferred in accordance with the invention.

Component f)

In one embodiment the compositions according to the invention comprise at least one filler from the group glass beads, ground glass, amorphous silica, calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No. 1317-65-3], mica [CAS No. 1318-94-1], phlogopite [CAS No. 12251-00-2], barium sulphate [CAS No. 7727-43-7], feldspar [CAS No. 68476-25-5] and montmorillonite [CAS No. 67479-91-8].

The filler to be employed as component f) is preferably employed in surface-modified form, particularly preferably with an adhesion promoter/adhesion promoter system, especially preferably based on silane. To this end silane chemistries are generally employed in amounts of 0.05 to 2 wt %, preferably 0.25 to 1.5 wt % and in particular 0.5 to 1 wt % based on the mineral filler for surface coating. However, pretreatment is not absolutely necessary.

The fillers to be employed as component f) may as a result of processing, preferably already during compounding, to afford the moulding material or in subsequent processing to afford the moulded article/article of manufacture in the moulding material or in the moulded article/article of manufacture, have a smaller d50 value than the fillers originally used.

In an alternative embodiment—if required and taking into account disadvantages of anisotropy during shrinkage—fibrous or acicular fillers may also be employed. Preference is given to carbon fibres, in particular carbon fibres based on polyacrylonitrile [CAS No. 308063-67-4], wollastonite [CAS No. 13983-17-0] or glass fibres [CAS No. 65997-17-3].

In accordance with the invention the term acicular mineral fillers is to be understood as meaning a mineral filler having a highly pronounced acicular character. Examples include in particular acicular wollastonites. The mineral preferably has a length:diameter ratio in the range from 2:1 to 35:1, particularly preferably in the range from 3:1 to 19:1, most preferably in the range from 4:1 to 12:1. The average particle size of the acicular mineral fillers is preferably <20 μm, particularly preferably <15 μm, especially preferably <10 μm, determined with a CILAS GRANULOMETER.

When glass fibres are employed, preference is given to using glass fibres made of E-glass. In a preferred embodiment the fibrous or acicular fillers are provided with suitable surface modifications, in particular surface modifications comprising silane chemistries, for better compatibility with component a).

In an alternative embodiment it is especially preferable to use as fibrous fillers glass fibres having a circular cross-sectional area and a filament diameter in the range from 6 to 18 μm, preferably 9 to 15 μm or flat glass fibres of noncircular cross-sectional area whose principle cross-sectional axis has a width in the range from 6 to 40 μm and whose secondary cross-sectional axis has a width in the range from 3 to 20 μm where the data reported in the glass fibre manufacturer technical datasheets are to be used to determine whether a glass fibre product belongs to this dimension range. For example, glass fibre CS7928 from Lanxess Deutschland GmbH (circular cross section, average diameter 11 μm) may be used with especial preference. In the context of the present invention cross-sectional area/filament diameter are determined by means of at least one optical method according to DIN 65571. Optical methods are a) optical microscope and ocular micrometer (distance measurement cylinder diameter), b) optical microscope and digital camera with subsequent planimetry (cross section measurement), c) laser interferometry and d) projection.

According to “http://de.wikipedia.org/wiki/Faser-Kunststoff-Verbund”, among glass fibres a distinction is made between chopped fibres, also called short fibres, having a length in the range from 0.1 to 1 mm, long fibres, having a length in the range from 1 to 50 mm, and continuous fibres, having a length L>50 mm. Short fibres are employed in injection moulding technology and may be directly processed with an extruder. Long fibres can likewise still be processed in extruders. Said fibres are widely used in fibre spraying. Long fibres are often added to thermosets as filler. Continuous fibres are used in the form of rovings or fabric in fibre-reinforced plastics. Products comprising continuous fibres achieve the highest stiffness and strength values. In glass flour the fibre length is in the range from 70 to 200 μm.

According to the invention, it is possible to use short glass fibres, long glass fibres or continuous glass fibres. Preference is given to using long glass fibres or continuous glass fibres, particularly preferably long glass fibres. However, the glass fibres can also be used as ground glass fibres.

The glass fibres are preferably modified with a suitable size system/an adhesion promoter/adhesion promoter system, particularly preferably based on silane.

Very particularly preferred silane-based adhesion promoters are silane chemistries of general formula (VI)

(X—(CH₂)_{q})ₖ—Si—(O—CᵣH₂ᵣ₊₁)₄—ₖ (VI)

in which the substituents are defined as follows:

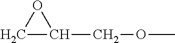

X: NH₂—, HO—,

q: an integer from 2 to 10, preferably from 3 to 4,

r: an integer from 1 to 5, preferably from 1 to 2,

k: an integer from 1 to 3, preferably 1.

Especially preferred adhesion promoters are slime chemistries from the group of aminopropyltrimethoxysilane, aminobutyltrimethoxysilane, aminopropyltriethoxysilane, aminobutyltriethoxysilane and the corresponding silanes comprising a glycidyl group as the substituent X.

To modify the glass fibres to be employed in an alternative embodiment the silane chemistries are preferably used in amounts in the range from 0.05 to 2 wt %, particularly preferably in the range from 0.25 to 1.5 wt % and in particular in the range from 0.5 to 1 wt % based on the amount of glass fibres for surface coating.

The glass fibres may, as a result of processing/compounding to afford the moulding material or the article of manufacture to be produced therefrom, have a smaller d97 or d50 value in the moulding material or in the article of manufacture than the glass fibres originally used. The glass fibres may, as a result of processing to afford the moulding material (compounding) or moulded article (injection moulding or extrusion), have shorter length distributions in the moulding material or in the moulded article than as originally used.

Component g)

Demoulding agents to be employed as component g) are preferably long-chain fatty acids, especially stearic add or behenic acid, salts thereof, especially calcium stearate or zinc stearate, and ester derivatives or amide derivatives thereof, especially ethylenebisstearylamide, montan waxes and low molecular weight polyethylene/polypropylene waxes. Montan waxes in the context of the present invention are mixtures of straight-chain saturated carboxylic acids having chain lengths of 28 to 32 carbon atoms.

In accordance with the invention particular preference is given to using lubricants and/or demoulding agents from the group of esters or amides of saturated or unsaturated aliphatic carboxylic acids having 8 to 40 carbon atoms with aliphatic saturated alcohols or amines having 2 to 40 carbon atoms and metal salts of saturated or unsaturated aliphatic carboxylic acids having 8 to 40 carbon atoms.

Very particular preference is given to using at least one lubricant and/or demoulding agent from the group of ethylenebisstearylamide, calcium stearate and ethylene glycol dimontanate.

The use of calcium stearate [CAS No. 1592-23-0]or ethylenebisstearylamide [CAS No. 110-30-5] is especially preferred. The use of ethylenebisstearylamide (Loxiol® EBS from Emery Oleochemicals) is especially particularly preferred.

Component h)

Customary additives of component h) are components distinct from components b), c), d), e), f) and g), preferably stabilizers, UV stabilizers, gamma ray stabilizers, laser absorbers, antistats, rheology modifiers, elastomer modifiers, emulsifiers, nucleating agents, acid scavengers, plasticizers, lubricants, dyes, laser marking additives, pigments and also flame retardants. The additives may be used alone or in admixture/in the form of masterbatches.

Stabilizers employed are phosphites, hydroquinones, aromatic secondary amines, in particular diphenylamines, substituted resorcinols, salicylates, citrates, benzotriazoles and benzophenones and also variously substituted representatives of these groups or mixtures thereof.

In one embodiment copper halides, in particular copper(I) iodide, are employed as stabilizers. Preference is given to employing at least one copper halide in combination with at least one alkali metal halide, preferably a chloride, bromide or iodide of sodium or potassium, in particular with potassium iodide. Alternatively or in addition, sodium hypophosphite, NaH₂PO₂, may also be employed.

It is also possible to employ as stabilizers at least one polyhydric alcohol, preferably selected from the group of dipentaetythritol [CAS No. 126-58-9] and tripentaerythritol [CAS No. 78-24-0], particular preference being given to dipentaerythritol. These polyhydric alcohols may also be employed in combination with the hereinabove-described stabilizers.

Preferably employed pigments/dyes are zinc sulphide, ultramarine blue, carbon black, phthalocyanines, quinacridones, perylenes, nigrosine and anthraquinones.

Preferably employed nucleating agents are talc, sodium or calcium phenylphosphinate, particular preference being given to talc. Talc is a pulverized magnesium silicate hydrate, having the chemical composition Mg₃[Si₄O₁₀(OH)₂], [CAS No. 14807-96-6].

Preferably employed add scavengers are hydrotalcite, chalk, boehmite and zinc stannate.

Preferably employed plasticizers are dioctyl phthalate, dibenzyl phthalate, butyl benzyl phthalate, hydrocarbon oils or N-(n-butyl)benzenesulphonamide.

Preferably employed elastomer modifier additives are one or more graft polymer(s) H of

H.1 5 to 95 wt %, preferably 30 to 90 wt %, of at least one vinyl monomer

H.2 95 to 5 wt %, preferably 70 to 10 wt %, of one or more graft substrates having glass transition temperatures of <10° C., preferably <0° C., particularly preferably <−20° C.

The graft substrate H.2 generally has an average particle size (d₅₀ value) of 0.05 to 10 μm, preferably 0.1 to 5 μm, particularly preferably 0.2 to 1 μm.

Monomers H.1 are preferably mixtures of

H.1.1 50 to 99 wt % of vinylaromatics and/or ring-substituted vinylaromatics, preferab/y styrene, α-methylstyrene, p-methylstyrene, p-chlorostyrene and/or (C₁-C₈)-alkyl methacrylates, preferably methyl methacrylate, ethyl methacrylate, and

H.1.2 1 to 50 wt % of vinyl cyanides, preferably unsaturated nitriles such as acrylonitrile and methacrylonitrile, and/or (C₁-C₈)-alkyl (meth)acrylates, preferably methyl methacrylate, n-butyl acrylate, t-butyl acrylate, and/or derivatives, preferably anhydrides and imides, of unsaturated carboxylic acids, preferably maleic anhydride and N-phenylmaleimide.

Preferred monomers H.1.1 are selected from at least one of the monomers styrene, α-methylstyrene and methyl methacrylate; preferred monomers H.1.2 are selected from at least one of the monomers acrylonitrile, maleic anhydride and methyl methacrylate.

Particularly preferred monomers are H.1.1 styrene and H.1.2 acrylonitrile.

Graft substrates H.2 suitable for the graft polymers for use in the elastomer modifiers are preferably diene rubbers, EP(D)M rubbers, i.e. those based on ethylene/propylene and optionally diene, acrylate, polyurethane, silicone, chloroprene and ethylene-vinyl acetate rubbers.

Preferred graft substrates H.2 are diene rubbers (in particular based on butadiene, isoprene etc.) or mixtures of diene rubbers or copolymers of diene rubbers or mixtures thereof with further copolymerizable monomers (for example as per H.1.1 and H.1.2), with the proviso that the glass transition temperature of component H.2 is <10° C., preferably <0° C., particularly preferably <−10° C. A particularly preferred graft substrate H2 is pure polybutadiene rubber.

Particularly preferred graft polymers H are ABS polymers (emulsion, bulk and suspension ABS), as described for example in DE-A 2 035 390 (=U.S. Pat. No. 3,644,574) or in DE-A 2 248 242 (=GB-A 1 409 275) or in Ullmann, Enzyklopädie der Technischen Chemie, vol. 19 (1980), p. 280 ff.

The gel content of the graft substrate H.2 is at least 30 wt %, preferably at least 40 wt % (measured in toluene). ABS is to be understood as meaning acrylonitrile-butadiene-styrene copolymer [CAS No. 9003-56-9] and is a synthetic terpolymer formed from the three different monomer types acrylonitrile, 1,3-butadiene and styrene. It is an amorphous thermoplastic. The quantitative ratios may vary from 15-35% acrylonitrile, 5-30% butadiene and 40-60% styrene.

The elastomer modifiers/graft copolymers H are produced by free-radical polymerization, for example by emulsion, suspension, solution or bulk polymerization, preferably by emulsion or bulk polymerization. Particularly suitable graft rubbers are also ABS polymers, which are produced by redox initiation with an initiator system composed of organic hydroperoxide and ascorbic acid according to U.S. Pat. No. 4,937,285.

Since, as is well known, the graft monomers are not necessarily completely grafted onto the graft substrate in the grafting reaction, in accordance with the invention graft polymers H are to be understood as also meaning products produced by (co)polymerization of the graft monomers in the presence of the graft substrate and coproduced in the workup.

Suitable acrylate rubbers are based on graft substrates H.2 which are preferably polymers of alkyl acrylates optionally with up to 40 wt % based on H.2 of other polymerizable, ethylenically unsaturated monomers. Preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, especially preferably chloroethyl acrylate, and mixtures of these monomers.

Crosslinking may be achieved by copolymerizing monomers having more than one polymerizable double bond. Preferred representatives of crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, in particular ethylene glycol dimethacrylate, allyl methacrylate; polyunsaturated heterocyclic chemistries, in particular trivinyl and triallyl cyanurate; polyfunctional vinyl chemistries, in particular di- and trivinylbenzenes; but also triallyl phosphate and diallyl phthalate.

Preferred crosslinking monomers are allyl methacrylate, ethylene glycol dimethacrylate, diallyl phthalate and heterocyclic chemistries having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02 to 5 wt %, in particular 0.05 to 2 wt %, based on the graft substrate H.2.

In the case of cyclic crosslinking monomers having at least 3 ethylenically unsaturated groups, it is advantageous to restrict the amount to below 1 wt % of the graft substrate H.2.

Preferred “other” polymerizable, ethylenically unsaturated monomers which, in addition to the acrylic esters, may optionally be used for producing the graft substrate H.2 are, for example, acrylonitrile, styrene, α-methylstyrene, acrylamide, vinyl C₁-C₆-alkyl ethers, methyl methacrylate, butadiene. Preferred acrylate rubbers used as graft substrate H.2 are emulsion polymers having a gel content of at least 60 wt %.

Further suitable graft substrates H.2 are silicone rubbers having graft-active sites, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

According to Kunststoffe 8, 2008, 119-121, laser absorbers are absorbers of laser light, preferably for inscription of plastic articles of manufacture. Preferred laser absorbers are selected from the group of antimony trioxide, tin oxide, tin orthophosphate, barium titanate, copper hydroxyphosphate, copper orthophosphate, potassium copper diphosphate, copper hydroxide, antimony tin oxide, bismuth trioxide and anthraquinone. Particular preference is given to antimony trioxide and antimony tin oxide. Very particular preference is given to antimony trioxide.

The laser absorber, in particular the antimony trioxide, may be used directly as a powder or in the form of masterbatches. Preferred masterbatches are those based on polyamide or those based on polybutylene terephthalate, polyethylene, polypropylene, polyethylene-polypropylene copolymer, maleic anhydride-grafted polyethylene and/or maleic anhydride-grafted polypropylene, it being possible to use the polymers for the antimony trioxide masterbatch individually or in a mixture. Very particular preference is given to using antimony trioxide in the form of a polyamide-6-based masterbatch.

The laser absorber can be used individually or as a mixture of two or more laser absorbers.

Laser absorbers can absorb laser light of a particular wavelength. In practice, this wavelength is in the range between 157 nm and 10.6 μm. Examples of lasers of these wavelengths are described in WO2009/003976 A1. Preference is given to using Nd:YAG lasers, which can achieve wavelengths of 1064, 532, 355 and 266 nm, and CO₂ lasers.

Preferred further flame retardants distinct from component b) are mineral flame retardants, nitrogen-containing flame retardants or phosphorus-containing flame retardants.

Preferred nitrogen-containing flame retardants are the reaction products of trichlorotriazine, piperazine and morpholine of CAS No. 1078142-02-5, in particular MCA PPM Triazine HF from MCA Technologies GmbH, Biel-Benken, Switzerland, melamine cyanurate and condensation products of melamine, for example melem, melam, melon or more highly condensed chemistries of this type. Preferred inorganic nitrogen-containing chemistries are ammonium salts.

It is further also possible to use salts of aliphatic and aromatic sulphonic acids and mineral flame retardant additives such as aluminium hydroxide, Ca—Mg carbonate hydrates (e.g. DE-A 4 238 122).

Also contemplated are flame retardant synergists from the group of oxygen-, nitrogen- or sulphur-containing metal chemistries, particular preference being given to zinc-free chemistries for the abovementioned reasons, especially molybdenum oxide, magnesium oxide, magnesium carbonate, calcium carbonate, calcium oxide, titanium nitride, magnesium nitride, calcium phosphate, calcium borate, magnesium borate or mixtures thereof.

In an alternative embodiment zinc-containing chemistries—if required—may however also be employed as component h). These preferably include zinc oxide, zinc borate, zinc stannate, zinc hydroxystannate, zinc sulphide and zinc nitride, or mixtures thereof.

In an alternative embodiment—if required and taking into account the disadvantages of loss of freedom from halogen—halogen-containing flame retardants may however also be employed as component h). Preferred halogen-containing flame retardants are commercially available organic halogen chemistries, particularly preferably ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene or brominated polyphenylene ethers, which can be used alone or in combination with synergists, especially antimony trioxide or antimony pentoxide.

Preferred phosphorus-containing flame retardants are organic metal phosphinates, for example aluminium tris(diethylphosphinate), aluminium phosphonate, red phosphorus, inorganic metal hypophosphites, particularly aluminium hypophosphite, metal phosphonates, in particular calcium phosphonate, derivatives of 9,10-dihydro-9-oxa-10-phosphaphenanthrene 10-oxides (DOPO derivatives), resorcinol bis(diphenyl phosphate) (RDP) including oligomers, and bisphenol A bis(diphenyl phosphate) (BDP) including oligomers, and also melamine pyrophosphate and, if required, melamine polyphosphate, also melamine poly(aluminium phosphate), melamine poly(zinc phosphate) or phenoxyphosphazene oligomers and mixtures thereof.

Further flame retardants for use as component h) are char formers, particularly preferably phenol formaldehyde resins, polycarbonates, polyimides, polysulphones, polyether sulphones or polyether ketones, and also antidrip agents, in particular tetrafluoroethylene polymers.

The flame retardants to be employed as component h) may be added in pure form, or else via masterbatches or compactates.

The inventive compositions/the moulding materials and articles of manufacture producible therefrom are characterized by very good flame resistance according to UL94 and glow wire testing (GWFI) coupled with high heat conductivity, low-warpage shrinkage and adequate mechanics.

Very good flame resistance in the context of the present invention is to be understood as meaning a V-0 UL94 classification at a wall thickness of not more than 1.5 mm and a GWFI value of not less than 85° C. at a wall thickness of not more than 1.5 mm. According to the invention high heat conductivity is to be understood as meaning thermal conductivity greater than 1.0 W/(m·K) when measured perpendicular to the flow direction of the test specimen (through plane) and thermal conductivity not less than 2.0 W/(m·K) when measured in the flow direction of the test specimen (in-plane).

The heat conductivity is measured according to the laser flash method as per EN821-2 using a Netzsch LFA447 Nanoflash® instrument.

After (injection) moulding, plastic-based articles of manufacture decrease in size by a certain percentage of their volume upon cooling on account of volume change during crystallization and thermal expansion, and so-called shrinkage takes place. According to “http://de.wikipedia.org/wiki/Schwindung#Schwindung_bei_Gie.C3.9Fharzen”, shrinkage is the change in volume of a material or workplace without removal of material or exertion of force. In plastics, shrinkage occurs on account of increasing crystallization which brings about a local increase in density. The missing volume/reduction in volume while retaining the same shape is then referred to as shrinkage. Shrinkage takes place through drying, cooling or chemical or physical transformation mechanisms in the material. Low shrinkage in casting resins based on thermoplastics is a quality criterion, since installed components can otherwise come under compressive stress, and gaps can form between these and other components to be wetted if adhesion is insufficient. In the case of injection-moulded articles of manufacture in electrical engineering/electronics, shrinkage can lead to ingress of moisture and to reduced stress resistance. Isotropic shrinkage is understood by those skilled in the art to mean equal shrinkage in all spatial directions.

Articles of manufacture according to the invention are preferably characterized by low-warpage shrinkage in all spatial directions, i.e. isotropic shrinkage. In accordance with the invention isotropic shrinkage is to be understood as meaning shrinkage of the article of manufacture where the quotient of processing shrinkage parallel to the direction of moulding and processing shrinkage perpendicular to the direction of moulding is greater than 0.8, preferably greater than 0.9.

Shrinkage during processing is determined, parallel and transverse to the moulding direction in each case, as per ISO 294-4 on test specimens having dimensions of 60 mm·60 mm·2 mm at a melt temperature of 260° C., a mould temperature of 80° C. and a hold pressure of 600 bar.

According to the invention adequate mechanics is preferably to be understood as meaning a flexural strength of ≧100 MPa, preferably ≧120 MPa, and an edge fibre elongation of ≧1.0%, preferably ≧1.2%.

Flexural strength in applied mechanics is a value for a flexural stress in a component under flexural load which when exceeded causes failure by fracture of the component part. It describes the resistance that a workpiece offers to deflection or fracture. In the short-term flexural test according to ISO 178, bar-shaped test specimens, preferably having dimensions of 80 mm·10 mm·4 mm, are placed with their ends on two supports and loaded in the centre with a flexing ram (Bodo Carlowitz: Tabellarische Übersicht über die Prüfung von Kunststoffen, 6th edition, Giesel-Verlag für Publizität, 1992, pp. 16-17).

According to “http://de.wikipedia.org/wiki/Biegeversuch”, the flexural modulus is determined in the 3-point bending test by positioning a test specimen on two supports and loading it in the centre with a test punch. For a flat specimen the flexural modulus is then calculated as follows:

E=Iᵥ³(X_{H}−X_{L})/4 D_{L}ba³

where the individual parameters are defined as follows:

E=flexural modulus in kN/mm;

Iᵥ=distance between supports in mm;

X_{H}=end of flexural modulus determination in kN;

X_{L}=start of flexural modulus determination in kN;

D_{L}=deflection in mm between X_{H} and X_{L};

b=specimen width in mm;

a=specimen thickness in mm.

The determined forces and deflections are used to calculate the characteristics for flexural strength and edge fibre elongation (Bodo Carlowitz: Tabellarische Übersicht über die Prüfung von kunststoffen, 6th edition, Giesel-Verlag für Publizität, 1992, pp. 16-17).

The safe configuration of mouldings and articles of manufacture made of plastic and subjected to long-term load requires material characteristics under static load which allow reliable conclusions to be drawn in this regard. Long-term investigations may be carried out under tensile, compression and flexural load and the variation in loading time and temperature should be taken into account. Surrounding media may moreover have a decisive impact on properties.

Determination of creep behaviour under three-point flexural load is effected according to DIN EN ISO 899-2. Test pieces having dimensions of 80 mm in length, 10 mm in breadth and 4 mm in thickness are to be used according to DIN EN ISO 178.

In contrast to the snort-term flexural test, edge fibre elongation ε_{f} (t) is calculated using the change in deflection with time f_{b} (t) in the flexural creep test under three-point loading according to DIN EN ISO 899-2/A1: 2012-03 (see: http://wiki.polymerservice-merseburg.de/index.php/Zeitstandbiegeversuch).

The GWFI value is determined by glow wire tests on end products and materials according to IEC 60695-2-12. The test procedure in the GWFI test is as follows: The specimens are exposed to the glow wire for 30 s in 50° C. steps from 500° C. to 900° C. and at 960° C. The specimen is rated as flame resistant at a particular temperature when the afterflame time after withdrawal of the glow wire is less than 30 s.

The specification UL94 Tests for Flammability of Plastic Materials for Parts in Devices and Applications from Underwriters Laboratories (UL) describes a method of assessing and classifying the flammability of plastics. Said specification was carried over unchanged into the standards IEC/DIN EN 60695-11-10 and IEC/DIN EN 60695-11-20. Classification was carried out using test specimens having dimensions of 125·13·S mm³. The thickness S must correspond to the smallest wall thickness in the intended application and must not exceed 13 mm. Often, testing is carried out using one or more of the values 0.40 mm, 0.75 mm, 1.5 mm and 3.0 mm. The tests are carded out with an open flame (Bunsen burner). The ignition source has an output of 50 W (flame of about 20 mm in height). Said ignition source is applied to the test specimen for 30 seconds or until the starting mark is achieved in the HB test and twice for 10 seconds in the V test and then removed again. The burn time, and in the V tests also the dripping of flaming particles, is assessed using a wad of cotton wool under the test specimen. Classification for the tested test specimen thickness is by the ratings HB (horizontal burn test) and V-0, V-1, V-2 (vertical burn test). These stand specifically—in order of increasing requirements—for:
HB: slow burning of a horizontally damped specimen (self-extinguishing or at a thickness of <3 mm; rate <75 mm/min (HB75); at a thickness of 3 to 13 mm; rate <40 mm/min (HB40)).
V-2: extinguishing of a vertically damped specimen within 30 seconds. Burning drips of plastic melt allowed.
V-1: as V-2 but no burning drips of plastic melt allowed. No more than 60 seconds of afterglow.
V-0: as V-1, but extinguishing of flame within 10 seconds. No more than 30 seconds of afterglow.

In a preferred embodiment the present invention relates to compositions comprising polyamide 6, magnesium hydroxide, boron nitride and ethylene bisstearylamide.

In a preferred embodiment the present invention relates to compositions comprising polyamide 6, magnesium hydroxide, boron nitride and 1,6-bis[3-(3,5-di-tert-butyl-4-hydroxyphenyl)propionylamino]hexane.

In a preferred embodiment the present invention relates to compositions comprising polyamide 6, magnesium hydroxide, boron nitride and talc.

In a preferred embodiment the present invention relates to compositions comprising polyamide 6, magnesium hydroxide, boron nitride, ethylene bisstearylamide and talc.

In a preferred embodiment the present invention relates to compositions comprising polyamide 6, magnesium hydroxide, boron nitride and ethylene bisstearylamide and 1,6-bis[3-(3,5-di-tert-butyl-4-hydroxyphenyl)propionylamino]hexane.

Method

The present invention further provides a method for producing compositions according to the invention in the form of moulding materials and articles of manufacture producible therefrom in which components a), b) and c) and optionally also at least one representative of components d), e), f), g) and h) are mixed in at least one mixing apparatus, discharged to afford a moulding material in the form of an extrudate, cooled until pelletizable and pelletized and subjected as matrix material to an injection moulding operation, a blow moulding operation or an extrusion. It is preferable when mixing is carried out such that per 100 parts by weight of component a) 100 to 280 parts by weight of component b) and 10 to 150 parts by weight of component c) are employed.

The mixing of the components is preferably accomplished at temperatures in the range from 220° C. to 400° C. by conjoint mingling, blending, kneading, extruding or rolling. Preferred mixing apparatuses are to be selected from compounders, corotating twin-screw extruders and Buss kneaders. It may be advantageous to premix individual components. The term ‘compound’ refers to mixtures of raw materials which have had additional fillers, reinforcers or other additives admixed with them. This does not result in dissolution of the individual raw materials in one another. Thus compounding combines at least two substances with one another to afford a homogeneous mixture. Compounding is intended to modify the properties of the raw materials to suit an application. A particular challenge is to avoid possible demixing of the compound over time. The procedure for producing a compound is referred to as compounding.

After mixing, compositions in the form of moulding materials are then preferably extruded, cooled until pelletizable and pelletized. In one embodiment, the pelletized material comprising the inventive composition is dried, preferably at temperatures in the range from 110° C. to 130° C., particularly preferably around 120° C., in a vacuum drying cabinet or in a dry air drier, preferably for a duration in the range of up to 2 h, before being subjected as matrix material to an injection moulding operation, a blow moulding operation or an extrusion process to produce inventive articles of manufacture.

The present invention thus also relates to a method of producing articles of manufacture wherein inventive compositions are blended, extruded to form a moulding material, cooled until pelletizable and pelletized and subjected as matrix material to an injection moulding, bow moulding or extrusion operation, preferably an injection moulding operation.

It may be advantageous to directly produce so-called semifinished products from a physical mixture produced at room temperature, preferably at a temperature in the range from 0° C. to 40° C., a so-called dryblend, of premixed components and/or individual components. In the context of the present invention semifinished products are prefabricated items and are formed in a first step in the production process of an article of manufacture. In the context of the present invention ‘semifinished products’ does not comprehend bulk goods, pelletized materials or powders because, unlike semifinished products, these are not geometrically defined solid objects and as such no “semifinishing” of the final article of manufacture has been effected. See: http://de.wikipedia.org/wiki/Halbzeug.

The methods of injection moulding, of blow moulding and of extrusion of thermoplastic moulding materials are known to those skilled in the art.

Methods according to the invention for producing polyamide-based articles of manufacture by extrusion or injection moulding are preferably carried out at melt temperatures in the range from 240° C. to 330° C., particularly preferably in the range from 260° C. to 310° C., very particularly preferably in the range from 270° C. to 300° C., and optionally also at pressures of preferably not more than 2500 bar, particularly preferably at pressures of not more than 2000 bar, very particularly preferably at pressures of not more than 1500 bar and especially preferably at pressures of not more than 750 bar.

Sequential coextrusion involves expelling two different materials successively in alternating sequence. In this way, a preform having a different material composition section by section in the extrusion direction is formed. Particular article sections may be endowed with specifically required properties by appropriate material selection, for example for articles having soft ends and a hard middle part or integrated soft gaiter regions (Thielen, Hartwig, Gust, “Blasformen von Kunststoffhohlkörpern”, Carl Hanser Verlag, Munich 2006, pages 1127-129).

In the method of injection moulding a moulding material comprising the inventive compositions, preferably in pellet form, is melted in a heated cylindrical cavity (i.e. plasticated) and injected under pressure into a temperature-controlled cavity as an injection moulding material. After cooling (solidification) of the material, the injection moulding is demoulded.

The following operations are distinguished:

1. plastication/melting

2. injection phase (filling operation)

3. hold pressure phase (because of thermal contraction during crystallization)

4. demoulding.

In this regard, see http://de.wikipedia.org/wiki/Spritzgie%C3%9Fen. An injection moulding machine comprises a closure unit, the injection unit, the drive and the control system. The closure unit includes fixed and movable platens for the mould, an end platen, and tie bars and the drive for the movable mould platen (toggle joint or hydraulic closure unit).

An injection unit comprises the electrically heatable barrel, the drive for the screw (motor, transmission) and the hydraulics for moving the screw and the injection unit. The injection unit serves to melt, meter, inject and exert hold pressure (because of contraction) on the powder/the pelletized material. The problem of melt backflow inside the screw (leakage flow) is solved by nonreturn valves.

In the injection mould, the incoming melt is then separated and cooled and the article of manufacture to be fabricated is thus fabricated. Two halves of the mould are always required therefor. In injection moulding, the following functional systems are distinguished:
runner system
shaping inserts
venting
machine mounting and force absorption
demoulding system and motion transmission
temperature control

In contrast to injection moulding, in extrusion an endless plastics extrudate of an inventive moulding material is employed in the extruder, the extruder being a machine for producing shaped thermoplastic mouldings. Reference is made here to http://de.wikipedia.org/wiki/Extrusionsblasformen. A distinction is made between single-screw extruders and twin-screw extruders, and also between the respective subgroups of conventional single-screw extruders, conveying single-screw extruders, contrarotating twin-screw extruders and corotating twin-screw extruders.

Extrusion plants comprise the elements extruder, mould, downstream equipment, extrusion blow moulds. Extrusion pants for producing profiles comprise the elements: extruder, profile mould, calibrating unit, cooling zone, caterpillar take-off and roller take-off, separating device and tilting chute.

Blow moulding (see: http://de.wikipedia.org/wiki/Blasformen) is a method of producing hollow articles from thermoplastics and is counted among the special injection moulding methods. Blow moulding requires a so-called preform which is produced in an upstream operation by conventional injection moulding. The first step of the actual blow moulding process comprises heating this preform. This employs especially infrared lamps since they are not only suited for automation but also have a high output and introduce a lot of heat energy into the semifinished product. After heating, the preform is introduced into the mould, or alternatively—depending on the machine construction—the heaters are removed from the mould. The closing of the mould results in a longitudinal stretching at the bottle neck, thereby holding the preform axially and also securing it in media-tight fashion. A gas is then introduced into the preform which expands under the applied pressure, thus reproducing the mould contours. For economic and environmental reasons the gas employed is often compressed air. After inflation, the hollow article produced cools down in the mould until it has sufficient rigidity and can be ejected.

The articles of manufacture producible in accordance with the invention from the moulding materials may preferably be employed for applications where a high flame retardancy coupled with high mechanical characteristics is required, preferably in the motor vehicle, electrical, electronics, telecommunications, solar, information technology and computer industries, in the household, in sport, in medicine or in the leisure industry, particularly preferably in components for current- and voltage-conducting component parts, in particular in domestic appliances and LED applications.

The present invention thus also relates to the use of thermoplastic moulding materials comprising the abovementioned compositions for producing articles of manufacture having enhanced flame retardancy coupled with high mechanical characteristics.

In one embodiment the articles of manufacture producible in accordance with the invention are semifinished products in the form of heat-stabilized composites based on endless fibres, also known as organopanels, or else encapsulated or overmoulded composite structures. The inventive compositions/the inventive heat stabilizer system may be used/may be present either in the thermoplastic matrix of the composite structure or in the moulding material to be moulded or in both components. Heat-stabilized composites are disclosed in WO 2011/014754 A1 for example and overmoulded composite structures are described in WO 2011/014751 A1 for example.

The invention further relates to the use of the inventive compositions for the production of inventive articles of manufacture in the form of fibres, films, moulded articles, composite structures and overmoulded composite structures. The articles of manufacture in the form of fibres, films, moulded articles, composite structures or overmoulded composite structures in turn find application as semifinished products in articles for the motor vehicle, electrical, electronics, telecommunications, information technology, solar and computer industries, for the household, for sport, for medical applications, for the leisure industry or in LED applications.

The present invention further relates to the use of inventive compositions as moulding materials for producing articles of manufacture in the form of fibres, films, moulded articles and as matrix material for producing composite structures and overmoulded composite structures. These are preferably employed as semifinished products which are in turn preferably used for producing articles of manufacture/components for current- and voltage-conducting component parts, preferably in domestic appliances and LED applications.

However, the present invention also relates to a method of flameproofing polyamides and articles of manufacture producible therefrom in the form of fibres, films, moulded articles, composite structures and overmoulded composite structures comprising employing a stabilizer system composed of magnesium hydroxide having an Si content of <15 000 ppm and boron nitride, preferably a stabilizer system composed of magnesium hydroxide having an Si content of <15 000 ppm, boron nitride and titanium dioxide or a stabilizer system composed of magnesium hydroxide having an Si content of <15 000 ppm, boron nitride and at least one heat stabilizer from the group of sterically hindered phenols comprising at least one structure of formula (I).

However, the present application also relates to a method of flameproofing polyamide/articles of manufacture producible therefrom in the form of films, fibres, moulded articles, composite structures and overmoulded composite structures in which a stabilizer system composed of magnesium hydroxide having an Si content of <15 000 ppm and boron nitride, preferably a stabilizer system composed of magnesium hydroxide having an Si content of <15 000 ppm, boron nitride and titanium dioxide or a stabilizer system composed of magnesium hydroxide having an Si content of <15 000 ppm, boron nitride and at least one heat stabilizer from the group of sterically hindered phenols comprising at least one structure of formula (I), is employed.

It will be understood that the specification and examples are illustrative but not limitative of the present invention and that other embodiments within the spirit and scope of the invention will suggest themselves to those skilled in the art.

### EXAMPLES

The components listed in table 1 were mixed in a ZSK 26 Compounder twin-screw extruder from Coperion Werner & Pfleiderer (Stuttgart, Germany) at a temperature of about 280° C., extruded into a water bath, cooled until pelletizable and pelletized. The pelletized material was dried to constant weight at 70° C. in a vacuum drying cabinet.

The pelletized material was then processed on an Arburg A470 injection moulding machine at melt temperatures between 270° C. and 290° C. and mould temperatures in the range from 80° C. to 100° C. to afford test pieces having dimensions of 125 mm·13 mm·1.5 mm for the tests according to UL94, test pieces having dimensions of 60 mm·45 mm·2.0 mm for producing the test specimens for the heat conductivity measurement and disks of 80 mm in diameter and 0.75 mm in thickness.

Flame resistance was determined according to the UL94V method (Underwriters Laboratories Inc. Standard of Safety, “Test for Flammability of Plastic Materials for Parts in Devices and Appliances”, p. 14 to p. 18 Northbrook 1998). The test pieces had dimensions of 125 mm·13 mm·1.5 mm.

Glow wire resistance was determined on the basis of GWFI (glow wire flammability index) glow wire testing in accordance with IEC 60695-2-12.

Heat conductivity was measured according to the laser flash method as per EN821-2 using a Netzsch LFA447 Nanoflash® instrument. Measurement of heat conductivity perpendicular to the flow direction of the test specimen (through plane) was effected on test specimens having dimensions of 12.5 mm·12.5 mm·2 mm, with the light pulse incident on the side having dimensions of 12.5 mm·12.5 mm. The respective test specimens were previously milled from a test piece having dimensions of 60 mm·45 mm·2.0 mm.

Measurement of heat conductivity in the flow direction of the test specimen (in plane) was effected on 6 test specimens arranged close together in rows and having dimensions of 12.5 mm·2 mm·2 mm which were each milled from a test piece having dimensions of 60 mm·45 mm·2.0 mm, then rotated about the vertical axis by 90° and finally reassembled such that the light pulse was in turn incident on a resulting surface of about 12 mm·12.5 mm.

Shrinkage during processing was determined, parallel and transverse to the moulding direction in each case, as per ISO 294-4 on test specimens having dimensions of 60 mm·60 mm·2 mm at a melt temperature of 280° C. and a mould temperature of 80° C. at a hold pressure of 600 bar.

As a measure of isotropy, warpage was then calculated as the quotient of shrinkage during processing parallel to the direction of moulding and shrinkage during processing transverse to the direction of moulding. In both cases the prepared test specimens were provided with a thin coating of graphite using a graphite spray prior to measurement. Reflection was measured with a spectrophotometer (Konica Minolta CM-2600d) on disks of 80 mm in diameter and 0.75 mm in thickness, the value at 500 nm including gloss reflection being used for the examples.

Materials Used:

Component a/1: polyamide 6 (Durethan® B26, from Lanxess Deutschland GmbH, Cologne, Germany)

Component b/1: magnesium hydroxide (Magnifin® 5HIV, Martinswerk GmbH, Bergheim, Germany)

Component c/1: boron nitride (BT BN006-HM boron nitride, RD Consulting, Oberscheinfeld, Germany)

Component g): ethylenebisstearylamide [CAS No. 110-30-5] in the form of Loxiol® EBS from Emery Oleochemicals

Further additives customarily used in polyamides such as g) nucleating agents (for example based on talc) and/or e) heat stabilizers such as 1,6-bis[3-(3,5-di-tert-butyl-4-hydroxyphenyl)propionylamino]hexane [CAS No. 23128-74-7] (Irganox® 1098, BASF, Ludwigshafen, Germany).

The compositions reported in table 1 were processed as described hereinabove.

TABLE 1

| | | ex. 1 |
|---|---|---|
| a/1) | [parts by wt.] | 100 |
| b/1) | [parts by wt.] | 175 |
| c/1) | [parts by wt.] | 30.5 |
| g) | [parts by wt.] | 0.6 |
| e) and/or h) | [parts by wt.] | 0.6 |
| UL94 (1.5 mm) | class | V-0 |
| GWFI (0.75 mm) | [° C.] | 960 |
| through-plane heat conductivity | [W/mK] | >1.5 |
| in-plane heat conductivity | [W/mK] | >3.0 |
| flexural strength | [MPa] | >120 |
| edge fibre elongation | [%] | >1.2 |
| shrinkage isotropy [parallel/perpendicular] | | >0.9 |
| reflectivity at 500 nm | [%] | >80 |

For inventive compositions/articles of manufacture obtainable therefrom (ex 1) table 1 shows not only high heat conductivity and very good flame resistance according to UL94 und IEC60695-2-12 (GWF) but also largely isotropic shrinkage and adequate mechanics in the flexural test.

What is claimed is:

1. A composition comprising:
a) polyamide 6 or polyamide 66;
b) magnesium hydroxide having an silicon content of <15,000 ppm; and
c) boron nitride.

2. The composition according to claim 1, wherein component b) has a purity of at least 96 wt % magnesium hydroxide.

3. The composition according to claim 1, wherein component b) additionally has an Fe content of <1500 ppm.

4. The composition according to claim 1, wherein the magnesium hydroxide has:
a purity of at least 98 wt % magnesium hydroxide;
a silicon content of less than 500 ppm; and
an iron content of less than 300 ppm.

5. The composition according to claim 1, wherein the composition comprises, per 100 parts by weight of component a):
100 to 280 parts by weight of component b); and
10 to 150 parts by weight of component c).

6. The composition according to claim 1, wherein the composition comprises, per 100 parts by weight of component a):
150 to 210 parts by weight of component b); and
20 to 45 parts by weight of component c).

7. The composition according to claim 1, further comprising d) titanium dioxide.

8. The composition according to claim 1, further comprising e) at least one heat stabilizer from the group of sterically hindered phenols comprising at least one structure of formula (I), 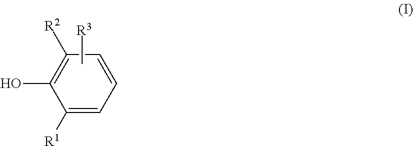
where R¹ and R² represent an alkyl group, a substituted alkyl group or a substituted triazole group, wherein radicals R¹ and R² may be identical or different and R³ represents an alkyl group, a substituted alkyl group, an alkoxy group or a substituted amino group.

9. The composition according to claim 1, further comprising f) at least one filler selected from the group consisting of glass beads, ground glass, amorphous silica, calcium silicate, calcium metasilicate, magnesium carbonate, kaolin calcined kaolin chalk, mica, phlogopite, barium sulphate, feldspar and montmorillonite.

10. The composition according to claim 1, further comprising g) at least one demoulding agent.

11. The composition according to claim 10, wherein the demoulding agent comprises at least one of long-chain fatty acids, salts thereof and ester derivatives or amide derivatives thereof, montan waxes, and low molecular weight polyethylene/polypropylene waxes.

12. The composition according to claim 6, further comprising any combination of two or more of:
d) titanium dioxide;
e) at least one heat stabilizer selected from the group consisting of sterically hindered phenols comprising at least one structure of formula (I), 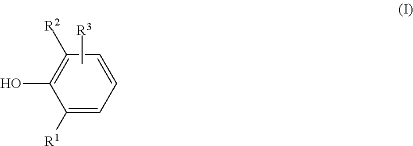
where R¹ and R² represent an alkyl group, a substituted alkyl group or a substituted triazole group, wherein radicals R¹ and R² may be identical or different and R³ represents an alkyl group, a substituted alkyl group, an alkoxy group or a substituted amino group;
f) at least one filler selected from the group consisting of glass beads, ground glass, amorphous silica, calcium silicate, calcium metasilicate, magnesium carbonate, kaolin, calcined kaolin, chalk, mica, phlogopite, barium sulphate, feldspar and/or montmorillonite; and
g) at least one demoulding agent selected from the group consisting of long-chain fatty acids, salts thereof and ester derivatives or amide derivatives thereof, montan waxes, and/or low molecular weight polyethylene/polypropylene waxes.

13. The composition according to claim 12, wherein:
the composition comprises each of components a), b), c), d), e), f) and g);
the magnesium hydroxide has:
a purity of at least 98 wt % magnesium hydroxide;
a silicon content of less than 500 ppm;
an iron content of less than 300 ppm;
an average particle size of d50 of 1.0 μm to 2.6 μm; and
the boron nitride have an average particle size d50 of 5.0 μm to 20 μm.

14. A moulding material comprising the composition according to claim 1.

15. An article of manufacture comprising the moulding material of claim 14.

16. The article of manufacture according to claim 15, wherein the article is a fiber, a film, a moulded article, a composite structure or an overmoulded composite structure.

17. The article of manufacture according to claim 16, wherein the quotient of processing shrinkage parallel to the direction of moulding and processing shrinkage perpendicular to the direction of moulding is greater than 0.8.

18. A method of producing compositions in the form of moulding materials and articles of manufacture producible therefrom, the method comprising:
mixing the components of the composition according to claim 1 in at least one mixing apparatus to produce a mixture;
discharged the mixture to afford a moulding material in the form of an extrudate;
cooling and pelletizing the extrudate as matrix material; and
forming an article of manufacture from the matrix material by at least one of an injection moulding operation, a blow moulding operation, or an extrusion.

19. A method of flameproofing polyamides and articles of manufacture produced therefrom in the form of fibres, films, moulded articles, composite structures and overmoulded composite structures, the method comprising mixing a polyamide with a stabilizer system composed of boron nitride, and magnesium hydroxide having an Si content of <15 000 ppm.

20. The method according to claim 19, wherein the polyamide is polyamide 6.
